(19) United States
(12) Patent Application Publication
(10) Pub. No.: US 2021/0137649 A1
(43) Pub. Date: May 13, 2021

(54) Abutment for an Endosseous Dental Implant

(71) Applicant: Epiphanostics GmbH, Holzkirchen (DE)

(72) Inventors: Axel Kirsch, Filderstadt (DE); Uwe Ernst Kratt, Weil der Stadt (DE)

(21) Appl. No.: 17/053,085

(22) PCT Filed: May 5, 2019
(86) PCT No.: PCT/DE2019/100402

§ 371 Date: Nov. 5, 2020

(30) Foreign Application Priority Data
May 7, 2018 (DE) 10 2018 110 946.6
Mar. 10, 2019 (DE) 10 2019 203 222.2

(51) Int. Cl. A61C 8/00

(52) U.S. Cl. CPC A61C 8/0053; A61C 8/0068; A61C 8/006; A61C 8/0054

(57) ABSTRACT

An abutment for an endosseous dental implant which abutment can be inserted into a jaw bone and a dental implant including the implant abutment.

The invention relates to an abutment for an endosseous dental implant and a dental implant insertable into the jawbone with a base body and the abutment according to the invention.

Nowadays, such dental implants, which are usually made of titanium or titanium alloys, usually have shapes approximating the natural tooth root, such as helical, cylindrical or stepped cylinders.

In most implant systems, implant abutments are placed on the actual implants, the so-called base bodies, which are connected to the implant by a screw that can be screwed into the implant body along the longitudinal axis of the implant. These establish the connection between the implant and the prosthetic construction on the implant. A distinction is made between removable and fixed constructions.

Wth such implants, there is often the problem that the desired longitudinal axis of the abutment does not coincide with the longitudinal axis of the implant. This problem occurs particularly when the most parallel abutments possible are desired on several implants with non-parallel axis directions.

In some applications, however, there is also a need to be able to position the abutment/fixing head at an angle to the base body, as the base body must occasionally be implanted at an angle into the jawbone, e.g. due to local bone atrophy, while the fixing head should have a different angular orientation for optimum attachment of the denture and introduction of the chewing forces absorbed by it.

For this purpose, it is already known to provide a ball head at the coronal end of a base body, on which a counterpart should be secured against rotation by means of a locking screw acting on the surface of the ball head. However, there is no guarantee that the counterpart can be firmly and securely connected to the base body.

Thus, a number of proposals for solutions to these problems are known in the state of the art.

An adjustable support for a prosthetic tooth in accordance with U.S. Pat. No. 4,832,601 comprises an abutment element with an opening for receiving a bolt element which engages with a nut element.

A stop element is sandwiched between a head portion of the bolt element and an enlarged collar portion of the nut element. The stop element can be swivelled to a desired position and the bolt and nut elements are tightened to lock the stop element in the desired position. A prosthetic tooth, which has an opening of complementary shape with respect to the stop element, engages the stop element to assume the angular orientation of the stop element.

Furthermore, U.S. Pat. No. 5,194,000 reveals an implant for use in oral and dental surgery, in particular in mandibular surgery, comprising a component in the form of a truncated cone substantially coaxial with the implant, at the coronal end of which a spherical element is provided, the spherical element being capable of being received in a corresponding cavity provided in the prosthesis in order to hold the prosthesis in relation to the implant.

A different solution is proposed in U.S. Pat. No. 5,195,891. This concerns an implant system and in particular an anchoring device for adjustably holding one or more prosthetic teeth or devices in a desired orientation relative to the insertion path of a restorative device, especially in the case of patient-removable restorative devices.

U.S. Pat. No. 5,302,125 describes a dental prosthesis implant that has angular rotation capability and improved locking between the implant holder and the abutment prosthesis.

A further solution for aligning the abutment mounted on the implant base bodies, whose longitudinal axes include an angle of up to 45° to each other, is proposed in DE-OS-19959366, for example. In this publication, an implant abutment is proposed which can be screwed to the implant by means of a screw, whereby the implant abutment consists of an abutment and a connecting part which can be placed on the implant at the basal of the abutment, whereby the abutment can be connected to the connecting part by a joining process, preferably by welding or gluing, with its longitudinal axis angled at any desired angle up to a limit angle relative to the longitudinal axis of the screw. However, this type of embodiment has the disadvantage that, after joining by welding or gluing, the components are fixed in the structure to each other and their position to each other can no longer be corrected.

A further development of the abutment for dental implants is described in EP1547543. The abutment described there for anchoring a dental prosthesis to a dental implant is provided with a post arrangement and a screw-in construction connected to it for screwing into the dental implant and has a ball joint between the post arrangement and the screw-in construction. The screw-in structure and the post assembly are provided with means for rigidly fixing the ball joint to the implant and the post assembly to the ball joint and the ball joint to itself. Disadvantages of this construction are the mechanical strength and the construction consisting of a multitude of individual parts.

According to WO2008/019774, a dental implant comprises two implant parts, a primary crown and a secondary crown, the secondary crown being the support for a prosthesis or bridge which can be placed on the outer shell of the secondary crown. The outer shell of the secondary crown is at least approximately circular or semi-circular in at least one plane and can be swivel-mounted accommodated in a bearing of the prosthesis or veneer.

An assembled angle connection for connecting an abutment to a dental implant at a predefined angle is described in WO2010/150188. The assembled angle connection comprises a basal element that can be connected to the dental implant and an apical element that can be connected to the abutment. The apical element is connected to the basal element, which forms a predefined angle. The assembly of the compound angle joint of the two elements allows to achieve a strong and stable connection between the base element and the dental implant, between the apical element and the abutment and between the base element and the apical element. The connection angle joint can be used in prostheses in order to make the best use of the bone structure of the jaw.

The EP2647347 concerns a prosthetic fixation with a support piece fixable in a dental implant and a fastening assembly that can be coupled to a prosthetic structure. The fastening assembly comprises a primary element with a substantially spherical cavity and is provided with a threaded through-bore into which a screw with a spherical head is inserted. Thus, the spherical head can be inserted into the inner area of the connecting section of the support and the wall forming the substantially spherical cavity of the primary element can be adjusted to partially and externally surround the connecting section of the support, so that the mounting assembly is rotationally coupled.

According to EP2684538, a screw channel-straightening device for a dental superstructure has a screw channel part and a part interacting with the implant. The proximal end of the screw channel part is cup-shaped so that the inner bottom surface has a concave shape and the outer bottom surface has a convex shape. The screw bore of the screw element seat is an oblong bore, and the part cooperating with the implant comprises a lower implant cooperation part for connection to a dental implant and an upper implant cooperation part. The lower implant-cooperating part has a distal concave seat and the upper implant-cooperating part has a proximal convex bottom surface with a radius corresponding to the radius of the concave seat of the lower implant-cooperating part to form a first ball joint. The upper implant cooperating part has a distal concave seat with a radius corresponding to the radius of the outer bottom surface of the screw channel part to form a second ball joint.

EP2835110 describes a prosthesis-mounting bracket which is freely adjustable in angle and position and has a ball joint and ball joint angle limiting cover.

U.S. Pat. No. 9,320,577 describes a dental implant abutment connection assembly comprising a seating portion adapted for fixation to a dental implant and a ball portion having a spherical head with a threaded post extending therefrom for mounting the ball joint in a user-selectable threaded bore in the socket to properly align an integral locating attachment cap attached to the ball head for fixing a dental prosthesis to the joint assembly.

A further fixing system for a dental implant having a spherical portion, the fixing system comprising a body with a seat forming a cavity, is described in WO2015/152815. The fixing system is characterised in that the body comprises at least two parts, which together form the seat. The parts are arranged so that the seat can embrace the spherical portion of the dental implant and so that the seat is movable between a first position in which the parts can move relative to each other and a second position in which the parts are prevented from moving relative to each other.

WO2016/170376 also describes a structure that allows continuous angle adjustment for fixing a single dental device in an implant.

Disadvantages of the systems known in the state of the art are the mechanical stability and position adjustments that decrease in strength as well as the constructions consisting of a multitude of individual parts.

The invention is therefore based on the task of further developing the generic structure of an implant abutment for a dental implant in such a way that a secured alignment of the structure and fixing of the components of the structure and further dental components with respect to each other can be achieved by simple means.

According to the invention, this task is solved by providing an abutment for a dental component such as a dental prosthesis, with
a substantially cylindrical abutment base with a ball head receptacle located at the coronal end relative to the arrangement in the jaw, and
a substantially cylindrical fixing head for a dental component, the fixing head having a through-bore coaxial with the longitudinal axis of the fixing head and a ball head arranged at the apical end with respect to the arrangement in the jaw,
wherein the ball head is surrounded by the ball head receptacle, preferably at least half of the ball head, and can be clampably fixed by the ball head receptacle, preferably by means of a clamping means.

Half-ball head in the sense of the above definition means, according to the invention, that the ball head arranged at the apical end below the section of the fixing head for the later fixation of the dental component such as dental prosthesis, conical cap, etc., in relation to the arrangement in the jaw, is at least half-ball surrounded by the ball head receptacle. When the ball head is inserted into the ball head receptacle, the ball head is pressed against the swivel opening in the ball head receptacle and slides into the ball head receptacle due to the elasticity of the material. In this position, the ball head can be secured against falling out without jamming due to its slightly larger diameter compared to the swivel opening. The insertion of the ball head into the receptacle can also be made easier by thermally shrinking the ball head by means of so-called cold shrinking with dry ice or liquid nitrogen. The ball head is then inserted into the ball head receptacle in the cooled state, brought to room temperature and then at least half of the ball head is embraced in the ball head receptacle. In a next step, the abutment consisting of the abutment base and the fixing head can be inserted into the implant and screwed into the implant with a fixing screw inserted through the through-bore in the fixing head.

The fixing head can be braced in the ball head receptacle by introducing bracing means through the through-bore, which causes the fixing head's ball head to jam in the ball head receptacle. Examples of clamping means are split pins, mandrels or preferably a clamping screw, whereby the latter can be screwed into an internal thread located in the through-bore in the fixing head and either causes jamming directly through contact with the ball head receptacle or indirectly jams the ball head against the ball head receptacle by pressing the apical end of the ball head apart.

In a further advanced embodiment, the ball head has at least one slot, in particular two slots cutting through the ball head to the through-bore to form ball head segments, wherein each slot being arranged at an angle of preferably 0° to 45°, preferably axially (0°), to the longitudinal axis of the through-bore.

In particular, the ball head may have at least three, four, five, six, eight or ten, preferably a multiple of two, slots penetrating/cutting through the ball head on both sides of the through-bore to form, for example, wedge-shaped ball head segments, each slot being arranged at an angle of 0° to the longitudinal axis of the through-bore, so that the axis of the through-bore is always in one plane with the planes formed/spanned by the slots, which have an angle of 360° divided by the number of slots to each other. According to the invention, a slot extends from the outside of the ball head to the through-bore. If there is an even number of slots, the slots are preferably arranged opposite to each other in one plane and divide the ball head into a number of ball head segments corresponding to the number of slots. If there are four, six, eight or more slots, the segments have the shape of wedge-shaped ball head segments in the number of four, six, eight or more.

The axial length of at least one of the slots cutting through the ball head to the through bore should be at least half the axial diameter of the ball head. Preferably, the slots in the ball head can be formed up to the transition area to the hollow cylindrical fixing head, up to the thread for the clamping screw. Thus, the axial length of the slot(s) can be approximately the same as the diameter of the ball head.

The at least one slot cutting through the ball head to the through-bore is preferably open towards the apical end of the ball head to facilitate jamming of the ball head over the ball head segments in the ball head receptacle. The ball head is preferably divided by slots into four, six or eight ball head segments in the manner of ball segment wedges. The ball head preferably has a spherical cavity, and the ball head segments then each have a cup-shaped form.

In particular, the through-bore penetrating the fixing head has a guide section and a clamping section and an internal thread arranged at the end of the clamping section facing the guide section, into which a clamping screw can be screwed. The clamping screw is dimensioned in length and diameter so that the clamping screw, in the screwed-in position, securely clamps the ball head segments with the ball head receptacle.

The through-bore penetrating the ball head and preferably widened in the ball head to form a hollow ball can have an inner collar or tapered edge in the clamping section in the area of the slots, preferably below the largest diameter range, usually in the middle of the axial length of the slots or below it, against which the clamping screw rests when screwed in, thus pressing the ball head segments apart and clamping them securely in position in the ball head receptacle in the screw-in position.

In order to facilitate insertion of the ball head into the ball head receptacle, particularly in the case of brittle materials, the abutment base may have a thread, preferably with one thread only, at the swivel opening facing the fixing head, which can be engaged with a corresponding thread, preferably with one thread only, on the ball head of the fixing head, preferably in the area of the largest diameter of the ball head, when the fixing head is inserted in the ball head receptacle.

Thus, the ball head can be screwed with the thread into the thread at the swivel opening of the ball head receptacle, and after one or more rotations, the ball head is embraced by the ball head receptacle and can be swivelled in the ball head receptacle within the range limited by the swivel opening.

In another embodiment, the abutment base may have at least one groove or projection on the swivel opening facing the fixing head, which can be engaged with a corresponding projection or groove on the ball head of the fixing head, preferably in the area of the largest diameter of the ball head, when the fixing head is inserted into the ball head receptacle, in each case in the manner of a tongue-groove connection. In this way, the ball head with the groove or tongue can be inserted in the corresponding tongue or groove at the swivel opening of the ball head receptacle, and after a short insertion the ball head is embraced by the ball head receptacle and can be swivelled in the ball head receptacle within the range limited by the swivel opening.

To improve mobility, the front edge of the abutment base can also be provided with a chamfer for the swivel opening, which allows the swivel angle to be increased.

The invention also relates to a dental implant with a base body and with an abutment as described above, and in particular a dental implant with a substantially cylindrical base body with an annular recess and with a bore coaxial with the annular recess, which can be inserted into a bore introduced into a jawbone and which has a thread apically for fixing a fixing screw, and the abutment which can be inserted into the annular recess of the base body and which consists of an abutment base and fixing head as described above. The abutment may have a bore penetrating the abutment base coaxially with the annular recess to receive a retaining screw with an apical external thread and a coronal screw head, or it may be provided with an external thread at the apical end of the abutment base.

The abutment can be fixed in the base body by means of the retaining screw, which can be inserted into the bore of the abutment base, or by the apical external thread on the abutment base. For this purpose, the retaining screw can be screwed into the thread located at the apical end of the base body by means of an Allen key engaging in the Allen key located in the screw head, which can be inserted through the axial bore of the retaining head into the bore of the abutment base and engaged with the Allen key screw head.

If the abutment is designed with a thread at the apical end, the abutment can be screwed into the base body, for example, by means of a tool such as a spanner, using spanner flats provided on the outside of the ball head receptacle.

The corresponding sections on the base body and abutment can be designed as tube-in-tube sections, which allow the abutment to be guided and supported in the base body without form-fitting elements, also known as indexing elements. In this type of design, the abutment consisting of the abutment base and fixing head is inserted into the base body via the abutment base. The abutment base is secured in the base body by means of the retaining screw or by means of the thread at the apical end, and the fixing head is swivelled into the desired position and secured in the abutment base by means of the clamping screw. On the fixing head, the dental component can be arranged like a dental prosthesis, a dental cone or a carrier for the dental prosthesis via an internal or external thread on the fixing head. The dental prosthesis or carrier can also be fixed to the fastening head via a thread in the screw head of the clamping screw or by means of dental cement.

In the embodiment of the abutment base with retaining screw or the embodiment of the abutment base with thread at the apical end, the corresponding sections on the base body and abutment can either be designed as tube-in-tube bearing(s) with corresponding diameters or as corresponding form-fitting sections with possibly further corresponding stepped cylindrical sections.

Thus, according to the invention, in a further embodiment the base body and the abutment can have form-fitting sections complementary to one another, the form-fitting section of the base body and the form-fitting section on the abutment base of the abutment preferably having two to six form-fitting element pairs complementary to one another in shape in the form of radially inwardly directed tongues on the base body which are axial to the longitudinal axis of the base body and corresponding grooves on the abutment in the manner of a tongue-groove connection.

According to the invention, the base body is provided with screw-in elements selected from inner polygons (preferably double, triple, square, pentagonal, hexagonal), cams, indentations and Morse taper Morse cone, preferably two to six, which are engaged for screwing the base body into the jaw by means of a screw-in tool with respectively complementary screw-in elements such as outer polygon (preferably double, triple, square, pentagonal, hexagonal), indentations, cams and Morse taper Morse taper on the screw-in tool.

In these embodiments, no screw-in elements are arranged on the abutment base that are complementary to the screw-in elements on the base body, and preferably the form-fitting elements, also known as indexing elements, are arranged on the abutment base in such a way that they have no contact with the screw-in elements on the base body and are designed separately from the screw-in elements. This embodiment is designed so that the application of force when the base body is screwed into the jaw with the aid of the screw-in tool takes place exclusively via the screw-in elements and additionally, if desired, via the contact of the screw-in element with the lateral surface and/or root of the tongue assigned in the screw-in or screw-out direction.

Preferably, a form-fitting element of a tongue-groove connection is arranged between two adjacent screw-in elements on the base body. Thus, with two to six complementary form-fitting elements in the form of radially inwardly directed tongues, which are axial to the longitudinal axis of the base body, a screw-in element can be arranged on the base body between two adjacent form-fitting elements.

If, in another embodiment, the base body is to be screwed into the jaw by means of the application of force via the abutment with the aid of a screw-in tool engaging key surfaces on the abutment/fixing head, the form-fitting section of the base body and the form-fitting section of the abutment base of the dental implant according to the invention can be screwed into the jaw by means of complementary screw-in elements which are brought into engagement with each other when the abutment base is inserted into the base body, wherein the base body and the abutment base are fixed non-rotatably relative to one another in the engagement position of the mutually complementary screw-in elements, and wherein the mutually complementary screw-in elements on the base body and abutment base are preferably designed as respective pairs of screw-in elements of complementary shape, selected from pairs of inner edge-outer edge (preferably), cam-indentations and Morse taper-Morse taper.

In particular, in the dental implant of the invention, the annular recess of the base body may comprise an apical guiding section, a form-fitting section arranged coronally to the apical guiding section and a coronal end section arranged coronally to the form-fitting section, and the abutment base may then correspondingly comprise an apical guiding section, a form-fitting section and a coronal end section corresponding to the respective sections of the base body.

In the embodiments according to the invention, when a retaining screw is used, the screw head of the retaining screw in the use position is preferably recessed in the abutment base in such a way that a swivel movement of the fixing head in the swivel opening of the abutment base is not impaired.

When using the abutment according to the invention with abutment base with ball head receptacle and with fixing head with apical ball head, it is not absolutely necessary to use indexing between the base body and abutment to align the fixing head, since the desired, mostly vertical alignment of the fixing head in the oral cavity of the patient can be achieved in any direction within the swivel opening after the abutment base has been fixed in place.

Other forms of implant and abutment are included in further embodiments of the invention, which are shown in particular in FIGS. 7 to 10. Thus, the invention also relates to dental implants in which the abutment base is rotatably mounted in the annular recess of the base body in the manner of a tube-in-tube mounting, optionally with at least two sections, which are almost equiradial to corresponding sections of the base body, and to such dental implants in which the base body and the abutment base are formed in one piece.

The components of the abutment or base body according to the invention can be produced by mechanical processing from blanks using CNC-processes or laser-processes. These include structure-removing processes as well as structure-building processes, which make use of the application of high-energy radiation to the blank or powder.

As a structure-removing process, laser ablation can be used very selectively to remove individual layers from the blank/substrate without significantly damaging the underlying layers or the substrate. The ablated structures can be spot-shaped, linear or flat.

According to the invention, structural or layer-building processes for the manufacture of three-dimensional objects such as implants are to be mentioned: Rapid Prototyping, Rapid Tooling, Rapid Manufacturing, Laser Sintering, and EBM.

Furthermore, laser microsintering or an ablative process can be used as a method for creating microstructures on the implant surface. The processing of ceramic powders in high quality is also possible.

The basic prerequisite for these processes is usually that the geometric data of the product are available in three dimensions and can be processed as layer data. From the available CAD data of the component, the data is converted into a data format, for example an STL format, in order to be able to structure the surface of a blank specifically by means of the aforementioned processes or to build up the blank in a structured way from powder.

The known devices, also for rapid prototyping processes, each have such a data interface, which serves to provide geometric information from three-dimensional data models.

By the inventors here, a process was proposed in which surfaces provided with regular/periodically repeating microstructures can be produced by exposing the surface of the blank to high-energy radiation in one or more patterns, which can be represented from a periodic function converted into an STL data set, whereby a structure-removing process is used. Alternatively, a blank provided with regular/periodically repeating microstructures can be produced using a structure-building process. In such a structure-building process, a quantity of powder present on a blank as a carrier can be exposed in one or usually several steps to the high-energy radiation in one or several patterns which can be represented from a periodic function converted into an STL data set, and the structure with the pattern is generated on the blank.

A less complex alternative is a structure-removing process in which the desired structure is created by removing surface material.

The blank obtained, which has been provided with a regularly microstructured surface by build-up or ablation processes, may also be subjected to a treatment to produce a second regular microstructure using a periodic function derived from a periodic function converted into an STL data set and/or a wet chemical treatment to produce a nanostructure.

The material of the abutment or implant can be selected from the group of metals, metallic alloys, ceramic materials (e.g. zirconium oxide), glasses and polymers (e.g. PEEK, polyetheretherketones) as well as combinations thereof.

The abutment and/or implant is preferably made of a material selected from the group of metals, metallic alloys and combinations thereof with ceramic materials. Preferably, the implant material used consists of metallic materials such as pure titanium or metallic titanium alloys, chrome/nickel/aluminium/vanadium/cobalt alloys (e.g. TiAlV4, TiAlFe2.5), stainless steels (e.g. V2A, V4A, chrome-nickel 316L) or a combination thereof with ceramic materials such as hydroxyapatite, zirconium oxide, aluminium oxide, where the metallic material is present as a composite material with ceramic material. The non-metallic materials, including polymers such as PEEK, can also be used alone without combination with other materials.

It may be of particular advantage if the abutment base is made of a material selected from the group of metals, metallic alloys and combinations thereof with ceramic materials, and the fixing head is at least partially made of a polymer material such as PEEK. In this design, a flexibility of the material, especially the polymer material of the fixing head is advantageous both when inserting the fixing head into the abutment base and when clamping/tightening the fixing head in the ball head receptacle of the abutment base. On the one hand, it is easier to insert the ball head into the ball head receptacle of the abutment base, and on the other hand, it is easier to clamp it in position using a clamping screw. After the implant has been inserted into the jaw and the abutment then inserted into the implant is usually aligned vertically, the dental component that is to be placed on the fixing head can be connected to the abutment base, e.g. using dental cement, thus creating a load-bearing and firm connection via the abutment to the base body.

Below are examples of the design of the abutment and its components as well as the single tooth implant according to the invention, explained in detail using the schematic drawings. Thereby, it is shown in:

FIG. 1 an example of a single tooth implant with an abutment according to the invention in an axial longitudinal section, as well as in a perspective top view of the single tooth implant from above.

FIG. 2 an example of the design of an implant base body used in the dental implant according to the invention as shown in FIG. 1 in an axial longitudinal section A-A along the plane shown on the right in the plan view, as well as a plan view of the base body from below (below) and from above (above);

FIG. 3 an example of the design of an abutment base used in the dental implant according to the invention as shown in FIG. 1 in an axial longitudinal section A-A along the plane shown on the left in the plan view on the right, as well as a plan view of the abutment base from above (above) and a plan view of the abutment base from below (below);

FIG. 4 an example of the design of a fixing head used in the dental implant of the invention as shown in FIG. 1 in an axial longitudinal section A-A along the plane shown on the left in the plan view, and a plan view of the fixing head from below (above);

FIG. 5 an example of the design of a tensioning screw used in the dental implant as shown in FIG. 1 in an axial longitudinal section A-A along the plane shown on the left in the plan view, and a plan view of the tensioning screw from above (below);

FIG. 6 an example of the design of a retaining screw used in the dental implant of the invention as shown in FIG. 1 in an axial longitudinal section A-A along the plane shown in the plan view on the right, as well as a plan view of the retaining screw from above (below).

FIG. 7 a further example of an abutment base used in the dental implant of the invention as shown in FIG. 1 in an axial longitudinal section A-A along the plane shown on the left in the plan view, as well as a plan view of the abutment base from above;

FIG. 8 a further example of an abutment base used in the dental implant as shown in FIG. 1 in an axial longitudinal section A-A along the plane shown on the left in the plan view, as well as a plan view of the abutment base from above;

FIG. 9 a further example of an abutment base used in the dental implant as shown in FIG. 1 in an axial longitudinal section A-A along the plane shown on the left in the plan view, as well as a plan view of the abutment base from above;

FIG. 10 an example of a one-piece design of an implant base body and an abutment base in axial longitudinal section A-A along the plane shown on the left in the plan view on the right, as well as a plan view from above and a plan view from below of the base body.

FIG. 1 shows the implant base body 10, as well as an abutment 40 inserted into the annular recess of the base body 10 and fixed in position by the retaining screw 120, with the abutment base 50 and the fixing head 80, which are fixed in position against each other by the clamping screw 100.

As shown in FIG. 2, the base body 10 is closed at its apical end shown in FIG. 1 below and has a blind bore 12 open towards its coronal end at the top in FIG. 1 with an internal thread 14 at the apical end of the blind bore 12. A retaining screw 120 for the abutment base 50, not shown in the drawing in FIG. 2, can be screwed into the internal thread. A hollow cylindrical annular recess 16 with a larger internal diameter than the bore 12 is connected to the internal thread 14 of the base body 10 in the coronal direction. The annular recess 16 has three areas 18; 20; 22 in the form shown. According to FIG. 2, the annular recess 16 has a guide section 18 coronally connected to the internal thread 14. The guide section 18 of the annular recess 16 is adjoined in the coronal direction by a form-fitting section 20, which has an increased internal diameter compared to the guide section 18 and can have an at least partially conical inner wall 32 with—in the design as shown in FIG. 2—three radially inwardly directed tongues 26. The tongues 26 are designed to correspond to the grooves 74 on the abutment base 50 shown in FIG. 3 in the manner of a tongue-groove connection and can preferably be dimensioned in such a way that they extend over the entire axial length of the form-fitting section 20. The tongues 26 can be formed from the base body by mechanical or electrochemical machining.

According to FIG. 2, an inner edge surface 30 can be provided as a screw-in element in the form-fitting section 20 between each two tongues 26, against which a corresponding outer edge surface of a screw-in tool not shown or, if so designed, a corresponding outer edge surface of an abutment 40 as shown in FIG. 3 can lie as a screw-in element during the process of screwing the base body 10 into the jaw. Thus, one or more screw-in elements designed as outer edge surface 72 can be designed on the abutment base in such a way that the flat surface of the outer edge surface, which can also be designed to project radially, can come into contact with one side surface of the tongue, but not with the tip of the tongue, at least in the screw-in direction, and can thus support the transmission of the torque to the base body without the tip of the bar being damaged during screw-in. Such an interaction/support or stop between the root of the tongue and the edge of the groove can be present in each pair of screw-in elements used in the dental implant of the invention in order to support the transmission of the torque in the direction of rotation, if radial tongues/grooves are arranged between two pairs of screw-in elements.

For mechanical and geometrical reasons, the use of three screw-in elements such as inner edge surfaces on the base body 10 is advantageous, but two to six screw-in elements such as inner edge surfaces can also be provided. On the inner edge surfaces, corresponding outer edge surfaces of a screw-in tool not shown or outer edge surfaces 72 of the abutment base 50 can engage as screw-in elements, as long as the form-fitting elements on base body 10 and abutment base 50 can be reliably engaged when inserting the abutment base 50. Between the inner edge surfaces, projections such as tongues 26 can be provided in an appropriate number in the design forms according to the invention, whereby the tongues and the inner edge surfaces can extend axially over the entire axial length of the form-fitting section for reasons of improved power transmission or indexing and enable torque transmission via the outer edge surfaces of the screw-in tool or also of the abutment base which are complementary in shape.

FIG. 3 shows the essentially cylindrical abutment base 50 with a through-bore 52 with the guide section 54 and the receiving section 56 for the clamping screw 100, which comes into contact with the cone collar 58 when screwed in. In the upper area, facing the coronal end, the ball head receptacle 60 is located with the diameter of the swivel opening 62, which is reduced in comparison to the maximum diameter of the ball head receptacle. On the coronal end face, a circumferential abutting surface 64 is provided, which has a circumferential chamfer 63 for the ball head receptacle 60 and swivel opening 62, which facilitates swivelling of the fixing head 80 in the ball head receptacle 60.

When the retaining screw 120 is screwed into the thread 14 provided at the apical end of the base body, the screw head 126 comes into contact with the cone collar 58. The screw head is dimensioned in such a way that it allows free swivelling of the ball head 82 located in the ball head receptacle 60.

The dental component not shown can be placed on the front face 64 in the form of a crown or a holder for a prosthesis. In order to ensure that the abutment base 50 fits securely in the base body 10, a guide section 66, a form-fitting section 68 and an end section 70 are provided on the outside of the abutment base 50 as shown in FIG. 3. The guide section is used for guiding when inserting the abutment base 50 into the base body 10. In the form-fitting section, form-fitting elements such as grooves are arranged, which serve to engage corresponding tongues on the base body and for indexing, and, if desired, screw-in elements are also provided, preferably in the form of external polygonal surfaces, which can be arranged preferably alternately between the form-fitting elements. In addition, indexing elements can be provided on the outside of the ball head receptacle, for example, to indicate the position of the groove or tongue in the apical end of the abutment base.

The abutment base 50 can be inserted into the base body after the base body has been screwed into the jaw and is secured against rotation by the form-fitting grooves and, if present, by the polygonal surface pairs in the base body and abutment.

The fixing head 80 shown in FIG. 4 has a through-bore 84, a fixing section 98 for the dental prosthesis and a ball head 82 arranged apically from the fixing section 98, which is intended for insertion in the ball head receptacle 60 of the abutment base 50. The through-bore has a guide section 94 at the coronal side and a clamping section 86 at the apical side, whereby the clamping screw 100 shown in FIG. 5 is inserted into the guide section after the fixing head 80 has been inserted into the ball head receptacle 60 in the abutment base 50 and is screwed into the thread 90 of the clamping section. When the screw tip 106 is in contact with the inner collar 88, which can also be designed as a hollow ball section in the ball head 82, the four ball head segments 96 shown in FIG. 4 in the top left-hand drawing in plan view from below are pushed apart when the tensioning screw 100 is screwed in further and clamp the ball head 82 in the desired position in the ball head receptacle 60 of the abutment base 50. According to the invention, more or less ball head segments 96 are also possible, although for manufacturing reasons, a multiple of two such as two, four, six or eight ball head segments 96 is advantageous.

As shown in FIG. 5, the length and diameter of the tensioning screw 100 must be dimensioned so that the tensioning screw 100 is in the screwed-in position in the fixing head 80 according to FIG. 4 rests with its screw tip 106 against an inner collar 88 which can be arranged circumferentially in the through-bore 84 preferably from the axial centre of the ball head 82 to the apical end of the ball head 82, and presses the ball head segments 96 formed by the slots 92 apart and presses them against the walls of the ball head receptacle 60 and thus jams them.

Although it is possible that the slots 92, which are arranged axially to the longitudinal axis of the through-bore 84, are not slotted as far as the apical end of the ball head or the fixing head and apically connecting bars are present between the segments 96, it is preferred that the slots extend as far as the apical end of the clamping section 86 and allow resilient radial movement of the ball head segments 96. This also facilitates removal of the fixing head after unscrewing the clamping screw 100. The ball head 82 can preferably have a reduced wall thickness around the axial through-bore 84 above the inner collar 88 and, if necessary, also below the inner collar 88—in the manner of a “hollow”—which allows the ball head segments 96 to expand when the screw tip 106 is in contact with the inner collar 88 when screwed in and allows the ball head segments 96 to spring back when the tensioning screw 100 is removed.

Although in the simplest embodiment, even one diametral slot, i.e. two slots (partial slots) extending to the axial longitudinal axis of the through-bore are sufficient for clamping, it is preferable to have at least three, preferably four or more slots, especially a multiple of two slots, which can preferably each be continuously aligned up to the longitudinal axis of the fixing head. Thus, in a plan view from the apical end towards the ball head, the wedge-shaped ball head segments 96, separated from each other by the slots, are formed, which are connected at their coronal end by a ball head base, which connects the individual approximately wedge-shaped ball head segments 96. In the area of the ball head segments, for example, a circumferential inner collar can also be provided in the area of the largest possible diameter of the ball head in the through-bore, against which the screw tip 106 of the tensioning screw 100 rests under contact pressure when the screw is screwed into the internal thread 90 of the fixing head and presses the ball head segments apart in the screw-in position.

FIG. 5 shows the tensioning screw 100 with the screw head 102 adjacent external thread 104 and the screw tip 106 for contact with the inner collar 88 of the fixing head 80. A hexagon socket or hexalobular socket 108 can be used to screw in the tensioning screw.

The retaining screw shown in FIG. 6 for fixing the abutment base in the base body 10 has a screw head 126 and a conical collar 124, with the external thread 122 located at the apical end of the retaining screw 120. As with the clamping screw shown in FIG. 5, the retaining screw can be screwed in via a hexagon socket (128) or hexalobular socket arranged in the screw head.

The embodiments of abutment base 50 shown in FIGS. 7 to 9 represent variants of the design of abutment base 50 shown in FIG. 3 without the abutment base 50 shown in FIG. 3 form-fitting elements 72 arranged in the form-fitting section 68. Accordingly, the sections of the annular recess 16 of the base body 10 that are complementary to the sections of the abutment base, which correspond to the abutment base 50 designs shown in FIGS. 7 to 9, also do not have any form-fitting elements 26 and no screw-in elements 30, but instead of the screw-in elements 30 on the outside of the end section 22 spanner flats similar to the spanner flats 132 on the abutment base 50 shown in FIG. 7.

Thus, FIG. 7 shows an abutment base 50 with a threaded section arranged apical to the base body 10, which can be screwed into the corresponding threaded section 14 in the base body 10. As shown above, the base bodies 10, which can be used for the embodiments shown in FIGS. 7 to 9, are not shown in the drawing, and the sections of abutment base 50 shown in FIGS. 7 to 9 have corresponding sections in the base bodies 10, but each without the corresponding form-fitting section 68. The abutment base 50 shown in FIG. 7 has a threaded section 130, and a guide section 66 and end section 70, with corresponding sections on the base body 10. Sections 66 and 70 are cylindrical sections and the abutment base 50 is screwed into the body 10 using a tool that engages the spanner flats 132, so that the ring collar 76 comes into contact with the front edge 28 of the body 10. The axial lengths of the sections 70, 66 and 130 are dimensioned so that when the abutment base 50 is screwed into the base body 10, the end face 28 and the ring collar 76 come into sealing contact via the spanner flats 132 or via an Allen key below the ball head receptacle 60 on the inside, not shown in the drawing. The advantage of screwing in the abutment base 50 via an Allen key located underneath the ball head receptacle 60, which is not shown in the drawing, is that the abutment base 50 and fixing head 80 can be assembled before screwing in and then the abutment base 50 can be screwed into the base body 10 via an Allen key inserted through the fixing head. This specification corresponds to the specification of the abutment base 50 by means of the fixing screw 120 in the version shown in FIG. 3. If the abutment base 50 shown in FIG. 7 is screwed into the base body 10 using the spanner flats and the fixing head 80 is inserted into the base body 10 after the abutment base 50 has been screwed into the base body 10, the fixing head is dimensioned and/or made of a material that allows the fixing head 80 to be inserted into the ball head receptacle 60 without heat treatment such as lime shrinkage.

FIG. 8 shows a further version of the abutment base 50 according to the invention, which instead of the abutment base 50 shown in FIG. 3 with guide section 18, form-fitting section 20 and end section 22, only has a hollow cylindrical tube section 140, which is inserted in a corresponding pipe section of a base body 10 not shown in the drawing and is held in position by a retaining screw 120, which is screwed into the apically arranged thread in the base body 10 and, guided by the hollow cylindrical guide section 140, comes to rest with the screw head in the receiving section 142.

The embodiment of the inventive abutment base 50 shown in FIG. 9 corresponds to the embodiment shown in FIG. 7 with a cylindrical section 152—as designated 140 in FIG. 8—arranged coronally to the threaded section 150. Like the design shown in FIG. 7, the design of FIG. 9 is screwed into the base body 10 using a tool acting on the spanner flats 132 or an Allen key apical to the ball head socket 60, which is not shown in the drawing. As with the designs shown in FIGS. 7 and 8, the Fixing Head 80 can be inserted into the abutment base 50 shown in FIG. 9 as described for FIGS. 7 and 8.

In the embodiment shown in FIG. 10, the abutment base 50 is formed in one piece with the base body 10, so that the base body 10 can be screwed into the jaw using the spanner flats 132 located on the outside of the ball head receptacle 60 of the abutment base. After screwing the implant with ball head receptacle 60 into the jaw, the fixing head 80 can be inserted into the ball head receptacle 60, aligned and fixed by means of the clamping screw 100. This design makes it possible in a very simple way to insert, align and fix the fixing head 80 for holding a dental component without the use of indexing elements. The preferred design of the fixing head 80 is such that it can be inserted into the ball head receptacle 60 without the use of a thermal treatment such as cold shrinking. Therefore, a preferably flexible material, for example a polymer material such as PEEK, is preferably used, which allows easy insertion of the ball head 82 made of Peek into the ball head receptacle 60. After aligning the fixing head in the ball head receptacle 60 with the desired position of the dental component to be attached to the fixing head, the ball head 82 can be fixed in position by tightening the clamping screw 100. In the next step, the dental component is placed on the fixing head 80 and bonded to the abutment base 50 at the front edge 64 and conical ring 65, for example with dental cement. This arrangement of the dental component can be used for all inventive embodiments of abutment 40 with abutment base 50 and fixing head 80.

### LIST OF REFERENCE SIGNS

10 Base body
12 Bore
14 Internal thread
16 Annular recess
18 Guide section
20 Form-fitting section
22 End section
26 Tongue
28 Front edge
30 Single screw-in element/internal polygonal surface
32 Internal wall
34 Clamping groove
36 Tongue root
38 Tongue side surface
40 Abutment
50 Abutment base
52 Through-bore
54 Guide section
56 Receiving section
58 Cone collar
60 Ball head receptacle
62 Swivel opening
63 Chamfer
64 Front face
65 Cone ring
66 Guide section
68 Form-fitting section
70 End section
72 External polygonal surface
74 Groove
76 Ring collar
80 Fixing head
82 Ball head
84 Through-bore
86 Clamping section
88 Inside collar
90 Internal thread
92 Slot
94 Guide section for clamping screw
96 Ball head segment
98 Fixing section
100 Clamping screw
102 Screw head
104 external thread
106 Screw tip
108 Hexalobular socket
120 Retaining screw
122 External thread
124 Cone collar
126 Screw head
128 Hexalobular socket
130 Thread section
132 Spanner flat
140 Tube section
142 Receiving section
144 Guide section
150 Thread section
152 Cylinder section
160 Implant with ball head receptacle

1. Abutment (40) for a dental implant, having:
a substantially cylindrical abutment base (50) having a ball head receptacle (60) located at the coronal end relative to the arrangement in the jaw, and
a substantially cylindrical fixing head (80) for dental prostheses, the fixing head (80) having a through-bore (84) coaxial with the longitudinal axis of the fixing head and a ball head (82) at the end facing the ball head receptacle (60),
wherein the ball head (82), surrounded in the ball head receptacle (60), is configured to be clampably fixed by the ball head receptacle (60).

2. The abutment according to claim 1, wherein the ball head has at least two slots cutting through the ball head to the through-bore to form ball head segments, wherein at least one slot is arranged at an angle of 0° to 45°, to the longitudinal axis of the through-bore.

3. The abutment according to claim 2, wherein the ball head has at least three; slots cutting through the ball head to the through-bore.

4. The abutment according to claim 2, wherein the axial length of at least one of the slots cutting through the ball head to the through-bore is at least half the diameter of the ball head.

5. The abutment according to claim 2, wherein at least one slot cutting through the ball head to the through-bore is at least partially open to the apical end of the ball head.

6. The abutment according to claim 1, wherein the through-bore penetrating the ball head has a guide section and a clamping section and an internal thread arranged at the end of the clamping section facing the guide section, into which a clamping screw is screwable as a bracing means, the clamping screw being dimensioned in length and diameter such that the clamping screw, in the screwed-in position, fixes the ball head in the ball head receptacle in a braced manner by the ball head segments.

7. The abutment according to claim 6, wherein the through-bore penetrating the ball head has an inner collar in the clamping section in the region of the slots, against which the clamping screw is supported in the screw-in position and thus secures the ball head segments with the ball head receptacle in the screw-in position in a positionally secure manner.

8. The abutment according to claim 1, wherein the abutment base has a thread, at the swivel opening facing the fixing head, which is engageable with a corresponding thread, on the ball head of the fixing head, when the fixing head is inserted into the ball head receptacle.

9. The an abutment according to claim 1, wherein the abutment base has at least one groove or projection on the swivel opening facing the fixing head, which is engageable as a tongue-groove connection with a corresponding projection or groove on the ball head of the fixing head, when the fixing head is inserted in the ball head receptacle.

10. Dental implant with a base body and with an abutment according to claim 1.

11. Dental implant with a base body and with an abutment according to claim 1, wherein the base body and the abutment base are formed in one piece.

12. Dental implant according to claim 10, with
a substantially cylindrical base body (10) insertable into a bore provided in a jawbone, with an annular recess (16) and with a bore (12) arranged coaxially to the annular recess (16) and having a thread (14) apically for fixing a retaining screw (120);
an abutment (40) insertable into the annular recess (16) of the base body (10), the abutment (40) having a bore (52) penetrating the abutment base (50) coaxially to the annular recess (16) for receiving a retaining screw (120); and
a retaining screw (120) with an apical external thread (122) and a coronal screw head (126), wherein the retaining screw (120) is insertable into the bore (52) of the abutment base (50) and screwed into the thread (14) of the base body (10).

13. The dental implant according to claim 12, wherein the base body and the abutment base have complementary form-fitting sections,
wherein the form-fitting section of the base body and the form-fitting section of the abutment base have two to six pairs of form-fittings elements which are complementary to one another in shape and which are in the form of radially inwardly directed tongues on the base body, which are parallel to the longitudinal axis of the base body, and corresponding grooves on the abutment base in the manner of a tongue-groove connection.

14. The dental implant according to claim 12, wherein screw-in elements are arranged in the annular recess of the base body, which are designed for the engagement of a form-complementary screw-in tool for screwing the base body into the jaw.

15. The dental implant according to claim 10, wherein the annular recess of the base body comprises an apical guide section, a form-fitting section arranged coronally to the apical guide section and a coronal end portion arranged coronally to the form-fitting section and wherein the abutment base comprises an apical guide section (66), comprises a form-fitting section and a coronal end section corresponding to the corresponding sections of the main body.

16. The dental implant according to claim 12, wherein the abutment base is rotatably mounted in the annular recess of the base body as a tube-in-tube bearing, optionally with at least two sections almost equiradially corresponding to sections of the base body.

17. An abutment according to claim 1, wherein the ball head is configured to be clampably fixed by the ball head receptacle by a clamping means.
